(19) United States
(12) Patent Application Publication
(10) Pub. No.: US 2020/0179090 A1
(43) Pub. Date: Jun. 11, 2020

(54) UNIVERSAL SERIAL BUS (USB) POWERED TOOTHBRUSH

(71) Applicant: 1842728 Ontario Inc, Barrie (CA)

(72) Inventors: Steve A. Copeland, Barrie (CA); Mitchell Thompson, Barrie (CA); Nicholas Teixeira, Angus (CA); William Battaglia, North Haledon, NJ (US)

(21) Appl. No.: 16/293,101

(22) Filed: Mar. 5, 2019

Related U.S. Application Data
(60) Provisional application No. 62/777,320, filed on Dec. 10, 2018.

(51) Int. Cl. A61C 17/22; H02J 7/00; H02J 7/02; H02J 50/10; H01R 33/94; H01R 33/76

(52) U.S. Cl. CPC A61C 17/224; H02J 7/0044; H02J 7/0052; H02J 7/025; H01R 33/945; H01R 33/94; H01R 33/7671; H01R 33/765; H02J 2007/0062; H02J 50/10

(57) ABSTRACT

A brushing system with a rechargeable toothbrush and associated charging components include a charging cup, a charging base, and a charger. The charging cup is seated on the charging base which in turn is engaged with the charger. The charger includes a universal serial bus (USB) receptacle that is configured to receive a USB header extending outwardly from the charging base. The charging base includes a first charging coil in a protrusion that extends upwardly from the charging base and into a receptacle in the charging cup. The charging cup includes a projection that is received in a recess of the toothbrush. The toothbrush includes a second charging coil that is brought into the proximity of the first charging coil when the toothbrush is placed in the cup. The toothbrush is charged by induction when prongs on the charger are engaged in an electrical wall outlet.

### CROSS REFERENCE TO RELATED APPLICATIONS

This application claims the benefit of U.S. Provisional Application Ser. No. 62/777,320, filed on Dec. 10, 2018; the disclosure of which is incorporated herein by reference.

### BACKGROUND

### Technical Field

The present invention relates to a powered toothbrush. Specifically, the present invention relates to a rechargeable powered toothbrush with an induction-brushing system. More particularly, the present invention relates to a rechargeable powered toothbrush having an induction-brushing system that utilizes a charging base which is integrated with a charger, where the charger may be plugged directly into a wall outlet.

### Background Information

Multiple studies have indicated, and it is widely accepted, that powered toothbrushes are more effective at cleaning teeth than manual toothbrushes. In particular, powered toothbrushes may rotate or oscillate at speeds faster than a manual toothbrush may be manipulated, resulting in more brush strokes per pass over each tooth. Powered toothbrushes therefore allowing for a deeper, more thorough cleaning with each brushing than do manual toothbrushes.

In the past, powered toothbrushes have typically been of one of two types. The first type of powered toothbrush has utilized a disposable battery wherein each time the battery is depleted, the battery is removed from the body of the toothbrush, is discarded, and then replaced with a fresh battery. The second type of toothbrush has utilized a rechargeable battery. This second type of powered toothbrush has typically been paired with a charging station that allows the toothbrush to be recharged between uses.

Many previously known rechargeable toothbrushes utilize induction charging, allowing the toothbrush to be placed on or near a charging base and to be wirelessly charged. Induction charging may allow the toothbrush to be constructed to be water-resistant and/or waterproof as there is no need for an open port for charging.

The problem with previously known charging bases is that they require a power source. Typically these charging bases are selectively engaged with a wall outlet through a wired plug. The charging base usually includes a stand or other implement to support and hold the toothbrush during the charging cycle and an electrical cord leads away from the stand and plugs into a standard wall outlet. The electrical cord may allow the stand to be placed on a bathroom countertop or shelf a distance away from the outlet. These types of charging bases may be messy and unsightly as the cord has to run across the countertop or shelf and has to extend upwardly from the countertop or shelf to the outlet. Furthermore, these corded bases may take up valuable countertop space and may occupy electrical outlets. This is particularly problematic in multi-person households where more than one person may have a rechargeable powered toothbrush in a shared bathroom. Such a scenario may cause additional frustration when an outlet is needed for another device, such as a hairdryer or a shaver. Still further, having electrical cords hanging downwardly from an electrical outlet and across a countertop may be hazardous if the user carelessly places the charging base too close to a basin. If the basin is filled with water and the charging base drops into the same, there is the potential for the user to be electrically shocked by the immersed charging base.

### SUMMARY

The present disclosure addresses these and other issues by providing a rechargeable brushing system. The brushing system comprises a rechargeable toothbrush and associated charging components include a charging cup, a charging base, and a charger. The charging cup is seated on the charging base which in turn is engaged with the charger. The charger includes a universal serial bus (USB) receptacle that is configured to receive a USB header extending outwardly from the charging base. The charging base includes a first charging coil in a protrusion that extends upwardly from the charging base and into a receptacle in the charging cup. The charging cup includes a projection that is received in a recess of the toothbrush. The toothbrush includes a second charging coil that is brought into the proximity of the first charging coil when the toothbrush is placed in the cup. The toothbrush is charged by induction when prongs on the charger are engaged in an electrical wall outlet.

In another embodiment, the rechargeable brushing system of the present disclosure may comprise a multi-port charging base which may be utilized to support and charge multiple rechargeable toothbrushes while utilizing a single wall outlet.

In one aspect, the present disclosure may provide a system for charging a rechargeable toothbrush comprising: a charger; a universal serial bus (USB) receptacle provided on the charger; a charging base adapted to support a rechargeable toothbrush thereon; a universal serial bus (USB) header extending outwardly from the charging base; wherein the USB header is operatively engageable with the USB receptacle. This exemplary embodiment or another exemplary embodiment may further provide a charging cup that is selectively engageable with the charging base, said charging cup being adapted to hold the rechargeable electric toothbrush therein. This exemplary embodiment or another exemplary embodiment may further provide wherein the charging base includes a first charging coil that is seated within a protrusion which extends outwardly from the charging base; and wherein the charging cup includes a depression into which the protrusion is received. This exemplary embodiment or another exemplary embodiment may further provide wherein the charging cup defines an interior cavity adapted to receive the rechargeable toothbrush therein; and the charging cup further include a projection that extends into the interior cavity; and wherein the projection defines the depression into which the protrusion from the charging base is received. This exemplary embodiment or another exemplary embodiment may further provide a rechargeable toothbrush having a second charging coil positioned around a recess defined in a bottom end of the rechargeable toothbrush; and wherein the projection of the charging cup is receivable within the recess in the rechargeable toothbrush. This exemplary embodiment or another exemplary embodiment may further provide wherein the placement of the projection of the charging cup within the recess of the rechargeable toothbrush permits induction charging of the rechargeable toothbrush via the first charging coil and the second charging coil when the charger is engaged in a wall outlet and is supplied with electric current. This exemplary embodiment or another exemplary embodiment may further provide wherein the charging base is adapted to support more than one rechargeable toothbrush and includes more than one USB header and the charger includes more than one USB receptacle; wherein the more than one USB header is operatively engaged with the more than one USB receptacle.

In another aspect, the present disclosure may provide a brushing system comprising: a powered toothbrush having a motor, a rechargeable battery, and a first charging coil; a charger having a universal serial bus (USB) receptacle and a plug; and a charging base having a top side, a bottom side, a second charging coil extending vertically upwards from the top side, and a USB header extending vertically downwards from the bottom side; the charging base removably connected below the powered toothbrush and above the charger such that the second charging coil is disposed within the first charging coil and the USB header is disposed within the USB receptacle; and wherein electrical energy is transferred into the system to inductively charge the rechargeable battery via the plug. This exemplary embodiment or another exemplary embodiment may further provide a charging cup having a base, an interior, an exterior, and a projection extending upwards from the base into the interior; the charging cup removably connected between the powered toothbrush and the charging base. This exemplary embodiment or another exemplary embodiment may further provide a first riser extending upwards from the top side of the charging base; and a second riser forming the base of the charging cup; wherein the first riser is configured to nest within the second riser. This exemplary embodiment or another exemplary embodiment may further provide wherein the charging base further comprises: a base protrusion extending vertically upwards from the first riser, the base protrusion having a slanted tip and containing the second charging coil therein. This exemplary embodiment or another exemplary embodiment may further provide wherein the powered toothbrush further comprises: a recess defined in a bottom end of the powered toothbrush, the recess being configured to accept the protrusion of the charging cup, the base protrusion, and the second charging coil inserted therein.

In another aspect, the present disclosure may provide a method of charging a powered toothbrush comprising: inserting a universal serial bus (USB) header on a bottom end of a charging base into a universal serial bus (USB) receptacle on a top end of a charger that is plugged into a wall outlet; directing an electrical current from the wall outlet through the charger and into the charging base via the USB receptacle and the USB header; converting the electrical current into electromagnetic energy via a first charging coil provided in the charging base; directing the electromagnetic energy from the first charging coil to a second charging coil provided within a powered toothbrush; converting the electromagnetic energy back into an electrical current; delivering the electrical current to a rechargeable battery provided within the powered toothbrush; and recharging the rechargeable battery. This exemplary embodiment or another exemplary embodiment may further provide inserting the first charging coil into an opening defined in the second charging coil prior to directing the electromagnetic energy from the first charging coil to the second charging coil. This exemplary embodiment or another exemplary embodiment may further provide connecting a top end of the charging base to a bottom end of a charging cup prior to inserting the first charging coil into the opening in the second charging coil such that the first charging coil extends into an interior of a projection provided in the bottom end of the charging cup and thereby into the opening in the second charging coil. This exemplary embodiment or another exemplary embodiment may further provide delivering the electrical current to the rechargeable battery in the powered toothbrush until the rechargeable battery reaches a maximum capacity; and terminating the delivery of electrical current to the rechargeable battery once the maximum capacity is reached. This exemplary embodiment or another exemplary embodiment may further provide delivering the electrical current to the rechargeable battery in the powered toothbrush until the rechargeable battery reaches a maximum capacity; and reducing the amount of electrical current being delivered to the rechargeable battery to maintain the rechargeable battery at its maximum capacity. This exemplary embodiment or another exemplary embodiment may further provide delivering the electrical current to the rechargeable battery in the powered toothbrush until the rechargeable battery reaches a maximum capacity; terminating the delivery of electrical current to the rechargeable battery until the rechargeable battery depletes below a preset level; and resuming delivery of the electrical current to the rechargeable battery to restore the rechargeable battery to its maximum capacity. This exemplary embodiment or another exemplary embodiment may further provide directing the electrical current through a printed circuit board (PCB) within the charging base before converting the current into the electromagnetic energy. This exemplary embodiment or another exemplary embodiment may further provide orienting the PCB within the charging base to be above and orthogonal to the plane of one or more prongs on the charger.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is an exploded left perspective view of a first embodiment of a rechargeable brushing system in accordance with an aspect of the present disclosure.

FIG. 2 is an exploded left perspective view of part of a rechargeable powered toothbrush showing the components within the toothbrush.

FIG. 3 is an exploded left perspective exploded view of the charging components of the rechargeable brushing system of FIG. 1.

FIG. 4 is an exploded longitudinal cross-section of the rechargeable brushing system of FIG. 1 as viewed from a right side.

FIG. 5 is a longitudinal cross-section of a lower portion of the rechargeable brushing system as viewed from a right side, showing the toothbrush engaged into the charging base.

FIG. 6 is an enlarged left perspective view of the rechargeable brushing system showing the system cut longitudinally along a midline and showing the relative engagement between the components thereof.

FIG. 7 is a top left perspective view of a second embodiment of a rechargeable brushing system in accordance with the present disclosure.

FIG. 8A is a top left perspective view of the charging base of the rechargeable brushing system shown in FIG. 7.

FIG. 8B is an exploded top left perspective view of the charging base of FIG. 7A.

Similar numbers refer to similar parts throughout the drawings.

### DETAILED DESCRIPTION

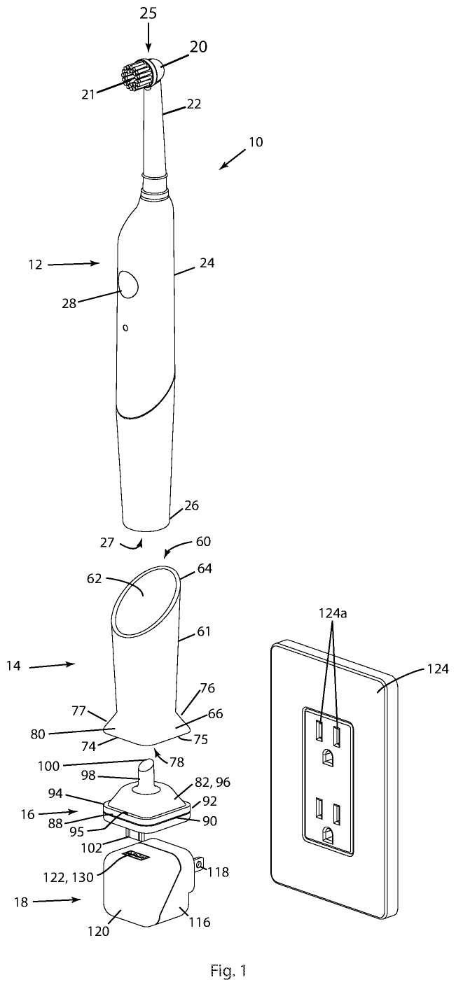

With reference to FIGS. 1-6, a rechargeable brushing system of the present disclosure is shown and generally indicated by the reference number 10. Brushing system 10 may include a powered toothbrush 12, a charging cup 14, a charging base 16, and a charger 18. Toothbrush 12 is of a type that may be externally powered.

Toothbrush 12 may have a head 20 having a series of bristles 21 arranged in any known bristle pattern as chosen by a person skilled in the art. The head 20 may be provided at one end of a neck 22 that extends outwardly from a body 24. According to one aspect, head 20 may be circular in shape and have a bristle pattern that is suitable for a circular head 20. According to another aspect, head may be rectangular in shape and have the bristles 21 arranged in a pattern suitable for a rectangular head. According to yet another aspect, head 20 may be of a replacement type head that is removably engageable with body 24. Head 20 may therefore include a connector that is compatible with body 24, thus allowing replacement heads to be purchased and easily installed on body 24.

Neck 22 may be of a generally cylindrical shape that is of a diameter smaller than body 24 thereby allowing a user to more easily position the head 20 in their mouth and reach all their teeth during brushing. According to one aspect, head 20 and neck 22 may form a single unit which may be removably and/or replaceably engageable with body 24.

Body 24 of powered toothbrush 12 may be of a generally cylindrical shape and may have a top end 25 and a bottom end 26. Top end 25 may be spaced apart from bottom end 26 defining therebetween a vertical direction. Neck 22 may be selectively engaged with top end 25. Body 24 may serve as both a handle for operating the toothbrush 12 and as a housing that contains various internal components, as discussed below. Bottom end 26 may define a recess 27 therein (best seen in FIG. 4) that is discussed further below.

According to one aspect, one or more O-rings, gaskets and the like may be positioned where neck 22 engages body 24 in order to seal the connection therebetween and prevent water intrusion therethrough.

Toothbrush 12 may further include a power switch 28 which may toggle the toothbrush 12 between an ON and an OFF condition for delivering power to the head 20 of toothbrush 12 as discussed further herein. According to one aspect, power switch 28 may be sealed to prevent water intrusion therethrough.

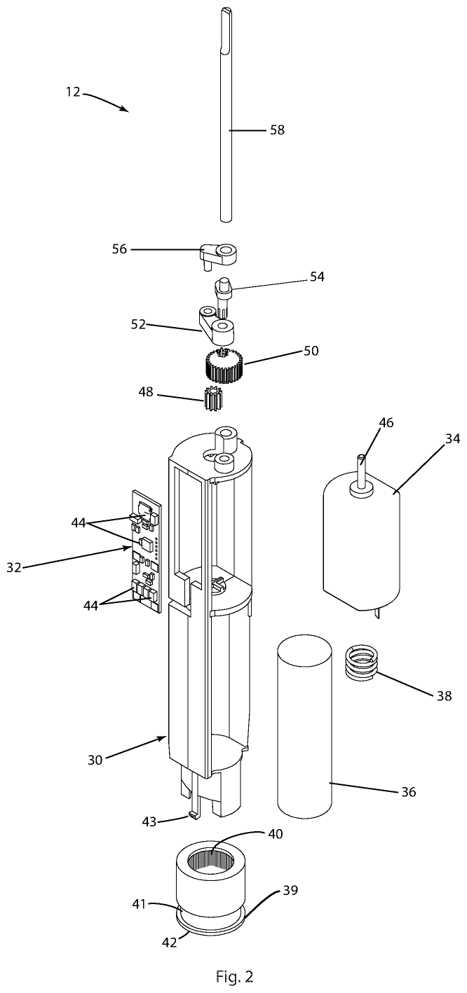

With reference to FIG. 2, the internal components of toothbrush 12 are shown and may include a chassis 30 that is shaped and sized to fit within an interior cavity of body 24. Chassis 30 may serve as a frame, providing structural support for the toothbrush 12 and for mounting or receiving other components. Specifically, chassis 30 may house a printed circuit board (PCB) 32, a motor 34, a rechargeable battery 36, a battery spring 38, and an outer charging coil 39.

PCB 32 may be a standard PCB including a series of PCB components 44. PCB components 44 may include standard components such as transistors, diodes, integrated circuit (IC) chips, resistors, and capacitors, as well as connectors thereto. PCB components 44 may also include a processor or micro-processor and a power component corresponding to power switch 28. At its basic level, PCB 32 and the components 44 thereon may control the powered toothbrush both in recharging cycles and in operational cycles as discussed further below.

According to one aspect, PCB 32 and/or PCB components 44 may include a programmable micro-processor which may control brush head 20 to vary the speed and/or brushing pattern of brush head 20 during a brushing cycle. According to another aspect, PCB 32 and/or PCB components 44 may include instructions and associated structure to provide haptic feedback to a user during a brushing cycle.

Motor 34 may be an electrical motor operable to drive brush head 20 when in use during a brushing cycle. Motor may further include a motor axle 46 which may extend outwardly from chassis 30 and into a motor transfer gear 48. Motor transfer gear 48 may be a standard gear as known and chosen by a person of skill in the art and may connect to linkage gear 50 which in turn may connect to a primary linkage 52, a secondary linkage 54, and a tertiary linkage 56. Each of primary, secondary, and tertiary linkages 52, 54, and 56 may operationally connect to a brush head axle 58 that is receivable into neck 22 and is configured to allow motor 34 to drive brush head 20 during a brushing cycle, as discussed further below.

Battery 36, may be a rechargeable battery in a standard size as chosen by a person of skill in the art. According to one aspect, battery 36 may be a Nickel-cadmium, Nickel-metal hydride, or Lithium-ion battery having a voltage of approximately 1.5 volts. According to another aspect, battery 36 may be a series of batteries in serial or parallel arrangement. Battery 36 may connect to motor 34 via battery spring 38, which may allow transfer of electrical energy from battery 36 to motor 34 when power switch 28 is in the ON position.

Battery 36 may further connect to outer charging coil 39, which may be operably engaged with a lower end of chassis 30. Outer charging coil 39 may be generally cylindrical-shaped with an opening 40 defined therein. Outer charging coil 39 further includes an exterior annular channel 41 and an annular lip 42. Outer charging coil 39 may be a standard induction charging coil that may convert electromagnetic energy into an electric current to charge battery 36 during a charging cycle, as discussed below.

Outer charging coil 39 may be disposed at the lower end of chassis 30 wherein outer charging coil 39 may slide over at least a portion of the lower end of chassis 30, such that at least a portion of chassis 30 will pass into opening 40. Lip 42 may engage a coil clip 43 that extends outwardly from the lower end of chassis 30. Coil clip 43 may secure outer charging coil 39 in place on chassis 30. Channel 41 may allow for inclusion of an O-ring, gasket, or the like (not shown) that may aid in sealing chassis 30 and the components housed thereon from water intrusion when bottom end 26 is connected to body 24 of toothbrush 12.

It will be understood that toothbrush 12 and the internal components thereof may be standard components and it will be further understood that a person of skill in the art may modify the internal components and/or configuration of toothbrush 12 according to the desired implementation without deviation from the scope herein.

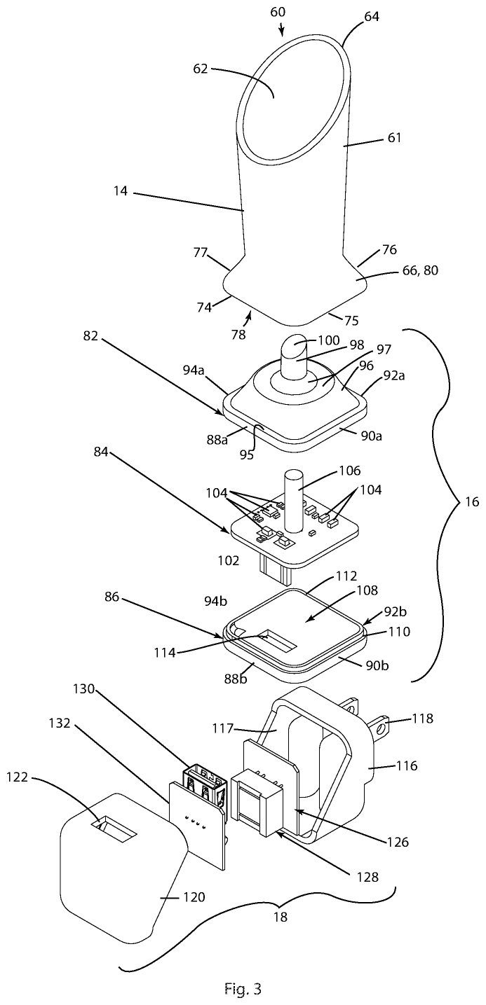

With reference now to FIGS. 3 and 4, charging cup 14 in accordance with an aspect of the present disclosure may include a generally cylindrical exterior wall 61 that bounds an defines an interior cavity 62. Wall 61 has a top end 60 where a rim 64 defines an opening through which interior cavity 62 may be accessed. A base 66 is provided at an opposite end of exterior wall 61. According to one aspect, rim 64 of charging cup 14 may be angled such that one region of rim 64 is located further away from base 66 than another region of rim 64. While being aesthetically pleasing, the extension of one region of rim 64 further outwardly from base to another region of rim 65 may configure charging cup 14 in such a way that the lower region may aid in enabling a user to insert further toothbrush 12 into the charging cup 14, while the higher region may aid in preventing toothbrush 12 from tipping or falling out of charging cup 14 when inserted into the same.

Interior cavity 62 of charging cup 14 may have a diameter larger than an outer diameter of toothbrush 12 and may be sized to accept the bottom end 26 of toothbrush 12 therein, or alternatively, is shaped and sized to accept the bottom end 26 and a portion of body 24 of toothbrush 12 therein.

As best seen in FIG. 4, charging cup 14 may include a bottom wall 72 that bounds and defines a lower region of the interior cavity 62. A projection 68 may extend upwardly from bottom wall 72 and into interior cavity 62 of charging cup 14. Projection 68 may be generally centrally located on bottom wall 72 and may include a top end 70 and an annular wall 71 that extends between top end 70 and bottom wall 72. Top end 70, wall 71, and bottom wall 72 may be continuous with exterior 61 of charging cup 14. Top end 70 and wall 71 of projection 68 may bound and define a depression 73 that is accessible from the bottom through an opening in bottom wall 72.

According to one aspect, top end 70 of protrusion may be slanted at an angle such that one region of top end 70 is located further from bottom wall 72 than another region of top end 70. In one example, top end 70 is oriented at an angle that is substantially parallel to the angle of rim 64 of charging cup 14. The slanted top end 70 may help prevent accidental dislodging or tipping of toothbrush 12 when toothbrush 12 is inserted into interior cavity 62 of charging cup 14 and projection 68 is received within recess 27 (FIG. 4) of bottom end 26 of toothbrush 12.

Base 66 of charging cup 14 is substantially continuous with exterior wall 61 of charging cup 14 and may have a first side 74, a second side 75, a third side 76, and a fourth side 77. The first through fourth sides 74, 75, 76, and 77 form a generally four-sided pyramid shape that has a bottom rim 78. First, second, third and fourth sides 74, 75, 76, and 77 bound and define a chamber 79 that is substantially continuous with depression 73. Chamber 79 is accessible through an opening bounded and defined by rim 78. First, second, third and fourth sides 74, 75, 76, and 77 of base 66 form a riser 80 which is substantially continuous with exterior wall 61. Exterior wall 61 tapers slightly inwardly from upper rim 64 to bottom wall 72. Riser 80 flares slightly outwardly from bottom wall 72 to rim 78.

With continued reference to FIGS. 1, 3, and 4, charging base 16 may generally comprise of three components, namely, charging base top 82, charging base Printed Circuit Board 84 (PCB 84), and charging base bottom 86. Charging base PCB 84 engages charging base bottom 86 and charging base top 82 snap fits to charging base bottom 86, thereby forming a protective shield around PCB 84.

When assembled as shown in FIG. 1, charging base 16 has a bottom region that is generally square in shape when viewed from above and comprises a first side 88, a second side 90, a third side 92, and a fourth side 94. This square bottom region is complementary to the square-shaped base 66 of charging cup 14. When charging cup 14 is placed on charging base 16, first side 88 of charging base 16 is aligned with first side 74 base 66; second side 90 is aligned with second side 75; third side 92 is aligned with third side 76; and fourth side 94 is aligned with fourth side 77.

It should be noted that each of the first side 88, second side 90, third side 92, and fourth side 94 are formed partially on charging base top 82 and partially on charging base bottom 86. Consequently, first side 88 is comprised of a first side section 88a of charging base top 82 and a first side section 88b of charging base bottom 86. Similarly, second side 90 is comprised of a second side section 90a of charging base top 82 and a second side section 90b of charging base bottom 86. Third side 92 is comprised of a third side section 92a of charging base top 82 and a third side section 92b of charging base bottom 86. Fourth side 94 88 is comprised of a fourth side section 94a of charging base top 82 and a fourth side section 94b of charging base bottom 86.

Charging base top 82 may further include a lip 95 and a riser 96. Riser 96 extends upwardly from first, second, third, and fourth side sections 88a, 90a, 92a, 94a and lip 95 is interposed between riser 96 and first, second, third, and fourth side sections 88a, 90a, 92a, and 94a. When charging cup 14 and charging base 16 are engaged, rim 78 of charging cup 14 will rest on lip 95. It should be noted that riser 96 may be shaped and sized to nest within chamber 79 of charging cup 14 when charging cup 14 and charging base 16 are engaged.

Charging base top 82 may also an annular shoulder 97 and a base protrusion 98 that extends upwardly from a generally central region of shoulder 97. Annular shoulder 97 is complementary to bottom wall 72 of charging cup 14 and protrusion 98 is complementary to projection 68 of charging cup 14. Protrusion 98 may include a slanted tip 100 that has a first region that is located further away from shoulder 97 that a second region thereof. Tip 100 may be oriented at an angle that is substantially identical to and parallel with the angle of top end 70 of projection 68. Base protrusion 98 may be configured to nest within depression 73 of projection 68 of charging cup 14 when system 10 is fully assembled as further described herein. The slanted top end 70 and tip 100 help ensure that charging base 16 is able to be engaged in charging cup 14 in only one orientation.

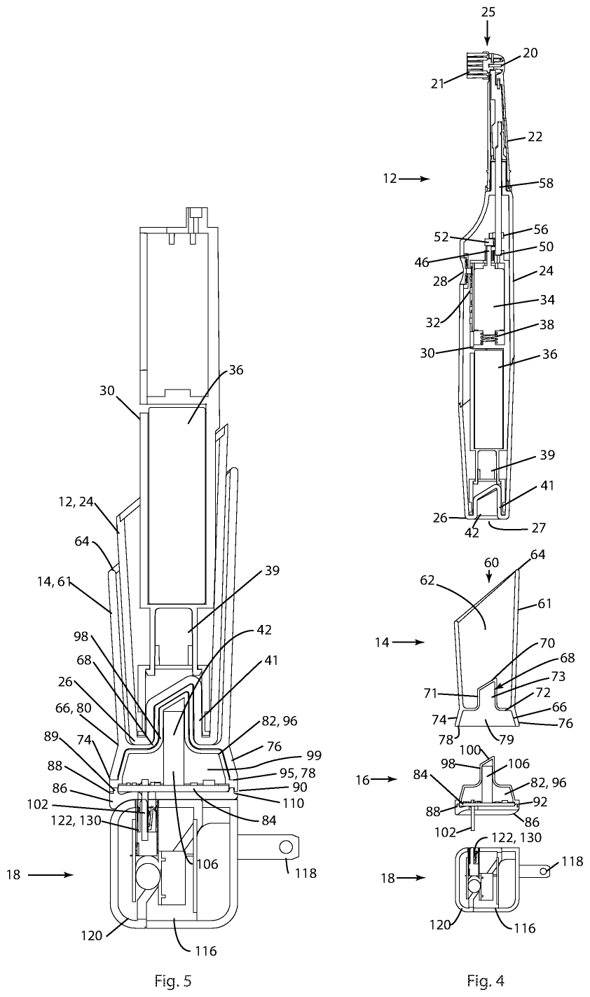

When charging base top 82 and charging base bottom 86 are engaged with each other, they may define an interior cavity 99 (FIG. 5) within which charging base PCB 84 may be received. As shown in FIG. 3, charging base PCB 84 may be a standard PCB having a generally square shape sized to fit within interior cavity 99. Charging base PCB 84 may include a male Universal Serial Bus (USB) header 102 extending vertically downwardly from a lower surface of PCB 84. USB header 102 may be a standard male USB connection and may be configured to deliver an electrical current therethrough. According to one aspect, USB header 102 may be any standard USB speed from 1.0-3.1 and may be any male connector compatible therewith, including, but not limited to, USB A, B, C, Mini-A, Mini-B, Micro-A, or Micro-B. PCB components 104 may be provided on an upper surface of charging base PCB 84. PCB components 104, similar to PCB components 44, may be standard components as chosen by a person of skill to effect the charging process as further described herein.

Furthermore, charging base PCB 84 may further include an inner charging coil 106 (FIG. 3) that extends vertically upward from the upper surface thereof. Inner charging coil 106 may be a standard induction charging coil that may convert an electric current into electromagnetic energy to deliver the electromagnetic energy to outer charging coil 39 during a charging cycle, as discussed below. Inner charging coil 106 may be generally cylindrical in shape and be configured to nest within base protrusion 98 of charging base top 82 when charging base 16 is assembled.

Charging base bottom 86 may include a platform 108 that includes an upstanding rim 112. First, second, third and fourth side sections 88b, 90b, 92b, and 94b are spaced a distance radially outwardly from rim 112. First, second, third, and fourth side sections 88b, 90b, 92b, and 94b terminate in a lip 110 that is located outwardly of rim 112. Rim 112 may extend vertically upwardly for a distance beyond lip 110. A first USB pass-through opening 114 may be defined in platform 108 and extend from an upper surface of platform 108 through to a lower surface thereof. Charging base bottom 86 may be sized to accept charging base PCB 84 therein such that charging base PCB 84 may fit onto platform 108 and within rim 112; with USB header 102 extending downwardly through first USB pass-through opening 114. Inner charging coil 106 extends upwardly from platform 108 and beyond rim 112. Rim 112 extends upwards beyond lip 110 and may form a perimeter wall around platform 108 to further contain base PCB 84 therein.

According to one aspect, the first, second, third, and fourth sections 88a, 88b; 90a, 90b; 92a, 92b; and 94a, 94b of walls 88, 90, 92, and 94 may include a latching mechanism to secure base top 82 and base bottom 86 together as a single unit when assembled. In one example, lip 110 of charging base bottom 86 may interlock within a recess 89 formed in charging base top 82. Lip 110 and recess 89 form the latching mechanism in this instance but it will be understood that other types of latching mechanisms may be utilized to secure charging base top 82 and charging base bottom 86 to each other.

Referring to FIG. 3, charger 18 may comprise a body 116, prongs 118, and a cover 120. Body 116 and prongs 118 may be integrated with each other. Body 116 and cover 120 are configured to be complementary to each other and to be secured to each other. Cover 120 has an upper wall that defines a USB pass-through opening 122 therein and through which the USB header 102 will be received when charging base 16 is seated on charger 18. Body 116 and cover 120 define an interior chamber 117 within which are received a primary charger PCB 126, a charger transformer 128, a female USB receptacle 130, and a secondary charger PCB 132. Charger 18 may be configured to plug into a standard wall outlet 124 (best seen in FIG. 1).

Charger 18, or more specifically prongs 118, may comprise a standard two prong (Type-A) or three prong, grounded (Type-B) plug operating at 120v. These standard plug types are common in the United States of America, as well as in North and Central America and in Japan. According to another aspect, prongs 118 may be any known plug type, including types C-N as determined by a person of skill based on the region in which the charger and/or system 10 is to be used. More particularly, prongs 118 may be configured to match the type of wall outlet(s) available for engagement of the charger in any particular region.

As indicated above, cover 120 may further define second pass-through opening 122. Opening 122 may be positioned on cover 120 so as to be aligned with USB receptacle 130 within interior 117. Furthermore, when charging base 16 is operationally engaged with charger 18, opening 122 in cover 120 will align with opening 114 in charging base 16. This configuration may allow male USB header 102 to be inserted through opening 122 and into engagement with USB receptacle 130 when charging base 16 is operationally engaged with charger 18, as discussed below.

Primary and secondary PCBs 126, 132 in charger 18, along with charger transformer 128 therein, may permit electrical energy to pass from wall outlet 124, through prongs 118, and into USB receptacle 130 where the electrical energy may be transferred to the USB header 102 and thereby into charging base 16. The charging process is further described below. Charger 18 may further include safety features, such as an automatic shut-off and/or a fault circuit interrupter.

According to one aspect, charging base 16 may sit on top of charger 18 when system 10 is fully assembled such that the plane of the charging base PCB 84 may be above and orthogonal to the plane of the prongs 118. Further according to this aspect, if charger 18 is to be used with a standard Type-A or Type-B outlet, the prongs 118 may be oriented substantially parallel in the vertical plane relative to the inner charging coil 106, the base protrusion 98, and the projection 68. Still further, the prongs 118 may be substantially parallel to the exterior wall 61 of the charging cup 14 and/or the toothbrush 12, when the system assembled, as discussed further below.

According to another aspect, charging base 16 may be easily separated from charger 18 by simply lifting charging base 16 off charger 18 and thereby disengaging USB header 102 from USB receptacle 130. Charging base 16 may then be moved to another USB charging port as desired and/or practical as determined by the specific implementation. This flexibility may allow for easy replacement of a charger 18 in the event a user's charger 18 fails to function or in the event charger 18 is lost or forgotten, such as when traveling.

Having thus described the structure of, the operation and a method of use will now be described herein.

FIG. 1 shows toothbrush 12 positioned above charging cup 14, which is in turn positioned above charging base 16, which is in turn positioned above charger 18. Charger 18 may be engaged with electrical outlet 124 by inserting prongs 118 of charger 18 into slots 124a of outlet 124. Charging base 16 may be engaged with charger 18 by inserting USB header 102 through opening 122 and thereby into interlocking engagement with USB receptacle 130 (FIG. 3) of charger 18. Charging cup 14 may be seated onto charging base 16 in such a manner that bottom rim 78 of charging cup 14 rests on lip 95 of charging base 16 and base protrusion 98 of charging base 16 is seated in depression 73 of projection 68. As is evident from FIG. 5, when charging cup 14 is placed on charging base 16, riser 96 of charging base 16 nests within the chamber 79 of charging cup 14 and interior and adjacent to riser 80 of charging cup 14. Toothbrush 12 may be inserted into charging cup 14 such that projection 68 of charging cup 14 is received in recess 27 in bottom end 26 of toothbrush.

Since base protrusion 98 may be received in projection 68, which may in turn be inserted in recess 27 and thereby into opening 40 of outer charging coil 39 of toothbrush 12, outer charging coil 39 of toothbrush 12 substantially surrounds at least a portion of inner charging coil 106 (which is received within base protrusion 98). This configuration permits induction charging of battery 36 of toothbrush 12 when charger 18 is inserted into outlet 124.

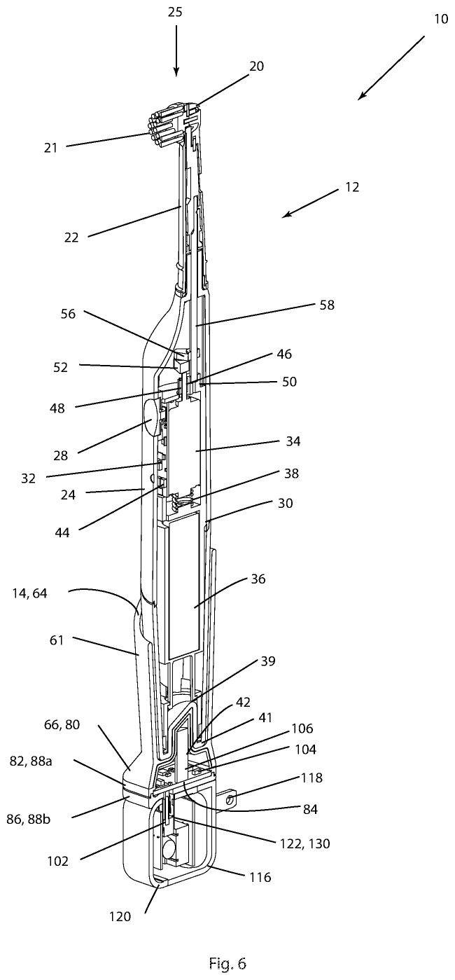

With continued reference to FIGS. 5 and 6, system 10 may have two basic operational conditions: A first operational condition may be when the powered toothbrush 12 is being used to clean a user's teeth, which is herein referred to as “a brushing cycle”. A second operational condition of system 10 may be a charging condition when the powered toothbrush 12 is docked within charging cup 14, which is attached to charging base 16 and charger 18 to recharge battery 36. This second operational condition is herein referred to as “a charging cycle”.

Accordingly, and in one embodiment, a brushing cycle may be a standard and approved method for cleaning teeth as taught by dental professionals, such the American Dental Association. To complete a brushing cycle, toothpaste is first applied to bristles 21 of head 20 and head 20 may be placed within the user's mouth. Power switch 28 of powered toothbrush 12 may be toggled to the ON position thereby activating motor 34 which may, through motor axle 46, motor transfer gear 48, linkage gear 50, primary, secondary, and tertiary linkages 52, 54, 56, and brush head axle 58, cause head 20 of toothbrush 12 to move in a predetermined pattern (e.g. in a circular motion for a round head 20 or a back-and-forth motion for a rectangular head). During this operational condition, battery 36 may be drained or depleted as toothbrush 12 draws power to operate brush head 20 for the duration of the brushing cycle. According to one aspect, additional features, such as indicator lights, indicator sounds, haptic feedback, and the like may also draw power from battery 36 during a brushing cycle.

Once a brushing cycle is complete, toothbrush 12 may be powered off by toggling power switch 28 to the OFF position and brush head 20 may be cleaned for storage.

According to one aspect, a single brushing cycle may not draw enough power to fully deplete battery 36. Thus, according to this aspect, as battery 36 is not completely discharged, toothbrush 12 may be stored and used for multiple brushing cycles without recharging. According to another aspect, battery 36 may be recharged after each brushing cycle.

After the stored energy in battery 36 has been discharged to a point that powered toothbrush 12 needs to be recharged, whether after each brushing cycle or after several brushing cycles, toothbrush 12 may be engaged in charging cup 14 to begin the charging cycle. Specifically, system 10 is assembled as previously described herein, and the charging cycle may be actuated when charger 18 is inserted into outlet 124.

The charging cycle requires that inner charging coil 106 be in close proximity to outer charging coil 39 to allow the most efficient transfer of energy to charge battery 36. Thus, as discussed above, riser 96 and base protrusion 98 of charging base 16 may be sized and configured to nest securely within riser 80 and projection 68 of charging cup 14 to allow for proper alignment and positioning of outer charging coil 39 within toothbrush 12 and inner charging coil within charging base 16. The charging of powered toothbrush 12 then may be accomplished in its most basic terms through the delivery of electrical energy from wall outlet 124 to battery 36. More particularly, electrical energy, in the form of an electrical current, is delivered from wall outlet 124, though prongs 118 and into charger 18. The primary PCB 126, transformer 128, and secondary PCB 132 may deliver this electrical energy into USB header 102 through USB receptacle 130 and into charging base 16. When the electrical energy is then delivered into charging base 16, base PCB 84 may cause inner charging coil 106 to convert the electrical energy from its present form as an electrical current to electromagnetic energy, which may then be transferred wirelessly out from inner charging coil 106 through known inductive charging standards. According to one aspect, the inductive charging standard may be Qi. According to another aspect, the inductive charging standard may be PMA. According to another aspect, the inductive charging standard may be any known and compatible standard as chosen by a person of skill appropriate for the desired implementation. Outer charging coil 39 may receive the wirelessly transmitted electromagnetic energy and may convert it back into an electrical current, which may be delivered to battery 36 to replenish the energy stored therein.

Once the charging cycle is complete, i.e. the battery 36 has reached its full and/or maximum capacity and may no longer accept incoming electrical current, one or more of the PCB 32, base PCB 84, primary charger PCB 126, and/or secondary charger PCB 132 may terminate the charging cycle by disrupting the flow of electrical energy through system 10.

According to one aspect, system 10 may switch from a charging cycle to a maintenance cycle wherein electrical energy is automatically supplied through system 10 to battery 36 anytime battery 36 drops below a preset charge capacity. According to another aspect, system 10 may switch from a charging cycle to a trickle charge cycle where a minimum amount of electrical energy is delivered to battery 36 at all times when the system 10 is engaged with outlet 124 to prevent battery discharge or depletion while toothbrush 12 is being stored in charging cup 14.

It will be understood that each component of system 10 may be assembled with its neighboring and/or related components in any order. According to another aspect, charger 18, charging base 16, and charging cup 14, may remain assembled and plugged into wall outlet 124, at all times with powered toothbrush 12, being removable therefrom as desired by a user.

According to another aspect, charger 18 and charging base 16 may remain assembled while charging cup 14 and toothbrush 12 may be removed as desired by a user.

According to another aspect, charging cup 14 may further be utilized to collect water to allow a user to rinse after a brushing cycle wherein charging cup 14 may then be rinsed and replaced on charging base 16 prior to or subsequent to the insertion of powered toothbrush therein in order to complete a charging cycle.

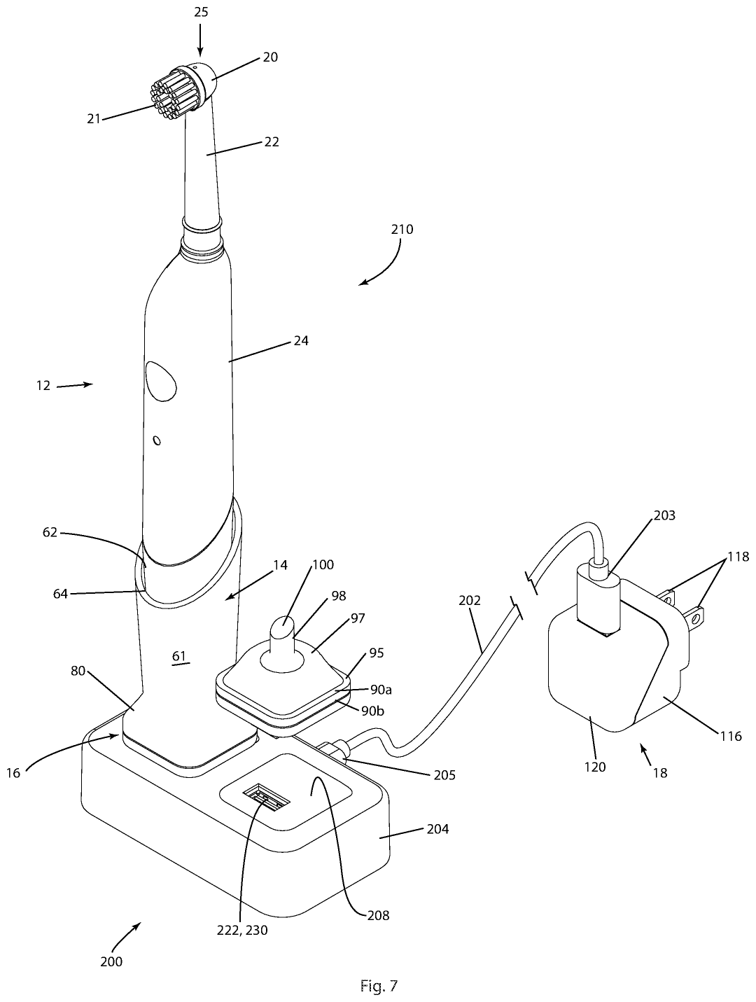

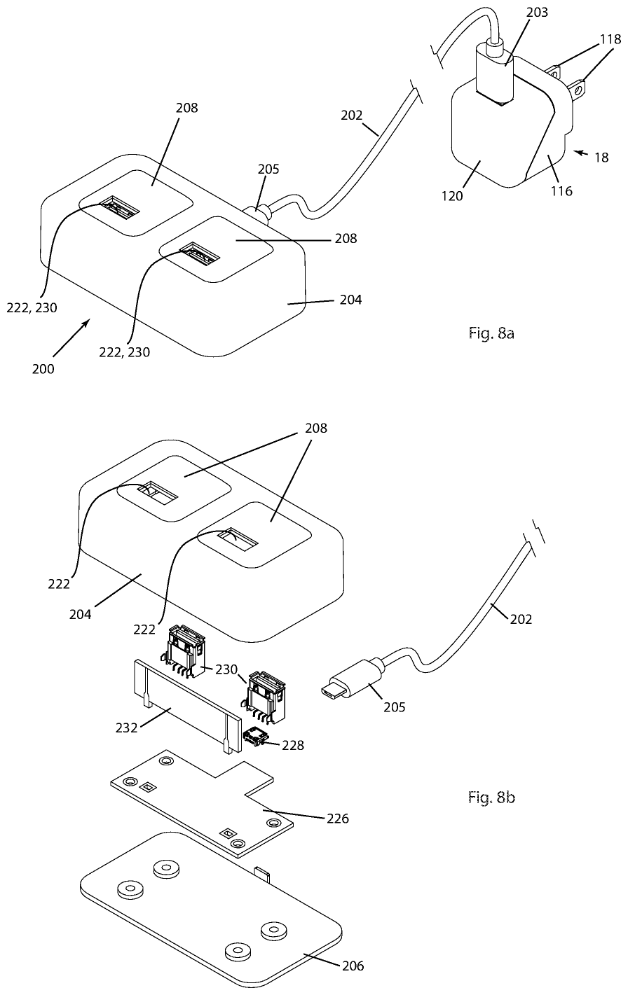

Referring to FIG. 7, 8A, and 8B, there is shown a second embodiment of a brushing system for a toothbrush that is generally indicated by the reference number 210. System 210 is utilized to charge one or more toothbrushes 12 and therefore includes one or more charging cups 14 (only one being shown) and one or more charging bases 16 as previously described herein. Brushing system 210 differs from brushing system 10 in that the charger is configured to receive two or more charging bases 16 therein.

FIG. 7, 8A, and 8B show a charger 218 that is configured to receive two charging bases 16 but it will be understood that charger 218 may be configured to receive more than two charging bases 16 therein. Charger 218 incorporates charger 18 as shown in FIG. 3 but further includes a charger housing 200 and an electrical cord 202 that is used to operatively engage charger housing 200 to charger 18.

Charger housing 200 may include a housing top 204 and a housing bottom 206 that are securable to each other. Housing top 204 and housing bottom 206 may be utilized to hold and protect various components within an interior compartment bounded and defined by top 204 and bottom 206 therein. A wall of housing top 204 defines two or more charging stations 208, each of which defines a USB pass-through opening 222 therein. At least one primary PCB 226, at least one transformer 228, two or more USB receptacles 230, and at least one secondary PCB 232 may be the components that are retained within the interior compartment of charger housing 200. It will be understood that the two or more USB receptacles 230 will be positioned in alignment with the two or more openings 222 in housing top 204. According to one aspect, the primary and secondary PCBs 226 and 232, may be combined into a single unit. The USB header 102 (FIG. 3) of each charging base 16 may be received through the opening 222 of one of the two charging stations 208 and be placed in operative engagement with the associated charger USB receptacle 230.

As indicated above, charger 218 may further include a cord 202 that may allow charger housing 200 to be connected to charger 18, which in turn may be engaged with an electrical outlet as previously described herein. According to one aspect, cord 202 may be a cord or cable having a USB connector 203 at one end that is selectively receivable in the opening 122 of charger 18. The other end of cord 202 may include a second connector 205 that is received in a connection port (not shown) of charger housing 200. In other instances, the other end of cord 202 may be fixedly engaged with charger housing 200. In either instance, cord 202 may be utilized to transfer power from charger 18 to charger housing 200. According to one aspect, the connection port on charger housing 200 may be a micro-USB receptacle. According to another aspect, the connection port may be any USB type receptacle as chosen by a person of ordinary skill in the art.

The use of charger 218 may allow flexibility in that charger 18 could still be utilized when only one toothbrush 312 needs to be charged while charger housing 200 could be stored or placed out of the way until it is needed to charge two or more toothbrushes 12 simultaneously.

According to another embodiment (not shown), cord 202 may be fixedly attached to charger housing 200 on one end while having a standard plug on an opposite end to connect charger housing 200 directly to a wall outlet.

In another embodiment, charger housing 200 may be provided with prongs similar to prongs 118 so that charger housing 200 might be plugged directly into a wall outlet without utilizing charger 18 and cord 202. Furthermore according to this embodiment, charger housing 200 may optionally include a support structure (not shown) to account for the additional weight applied to charger housing 200 by the additional components and additional toothbrush(es) 12. Furthermore according to this aspect, charger housing 200 may be configured to be mounted on a wall, or may include a mounting bracket (not shown) to allow charger housing 200 to be mounted on a wall.

Although described herein with reference to charger 18, it will be understood that the brushing cycle and charging cycle may be substantially identical when using charger 218. Specifically, when utilizing charger 218, USB header 102 may be operatively engaged into USB receptacle 230 on charger housing 200 and power may flow therethrough to charger battery 36 as previously described herein.

It will be further understood that the specific mechanism of induction charging utilized herein may be adapted or modified depending upon the desired implementation as chosen by a person of skill in the art. As induction charging of powered toothbrushes is generally known, variations on the induction charging process may be further applied as chosen by a person of skill in the art.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” may refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “comprising of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Comprising essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it may be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it may be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown may apply to other embodiments. It will also be appreciated by those of skill in the art that references to a structure or feature that is disposed “adjacent” another feature may have portions that overlap or underlie the adjacent feature

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” may encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral” and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Additionally, any method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “comprising of” and “comprising essentially of” shall be closed or semi-closed transitional phrases, respectively, as set forth in the United States Patent Office Manual of Patent Examining Procedures.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. A system for charging a rechargeable toothbrush comprising:
a charger;
a universal serial bus (USB) receptacle provided on the charger;
a charging base adapted to support a rechargeable toothbrush thereon; and
a universal serial bus (USB) header extending outwardly from the charging base; wherein the USB header is operatively engageable with the USB receptacle.

2. The system as defined in claim 1, further comprising:
a charging cup that is selectively engageable with the charging base, said charging cup being adapted to hold the rechargeable electric toothbrush therein.

3. The system as defined in claim 2, wherein the charging base includes a first charging coil that is seated within a protrusion which extends outwardly from the charging base; and wherein the charging cup includes a depression into which the protrusion is received.

4. The system as defined in claim 3, wherein the charging cup defines an interior cavity adapted to receive the rechargeable toothbrush therein; and the charging cup further include a projection that extends into the interior cavity; and wherein the projection defines the depression into which the protrusion from the charging base is received.

5. The system as defined in claim 4, further comprising:
a rechargeable toothbrush having a second charging coil positioned around a recess defined in a bottom end of the rechargeable toothbrush; and wherein the projection of the charging cup is receivable within the recess in the rechargeable toothbrush.

6. The system as defined in claim 5, wherein the placement of the projection of the charging cup within the recess of the rechargeable toothbrush permits induction charging of the rechargeable toothbrush via the first charging coil and the second charging coil when the charger is engaged in a wall outlet and is supplied with electric current.

7. The system as defined in claim 1, wherein the charging base is adapted to support more than one rechargeable toothbrush and includes more than one USB header and the charger includes more than one USB receptacle; wherein the more than one USB header is operatively engaged with the more than one USB receptacle.

8. A brushing system comprising:
a powered toothbrush having a motor, a rechargeable battery, and a first charging coil;
a charger having a universal serial bus (USB) receptacle and a plug; and
a charging base having a top side, a bottom side, a second charging coil extending vertically upwards from the top side, and a USB header extending vertically downwards from the bottom side; the charging base removably connected below the powered toothbrush and above the charger such that the second charging coil is disposed within the first charging coil and the USB header is disposed within the USB receptacle; and wherein electrical energy is transferred into the system to inductively charge the rechargeable battery via the plug.

9. The brushing system of claim 8, further comprising:
a charging cup having a base, an interior, an exterior, and a projection extending upwards from the base into the interior; the charging cup removably connected between the powered toothbrush and the charging base.

10. The brushing system of claim 9, further comprising:
a first riser extending upwards from the top side of the charging base; and
a second riser forming the base of the charging cup; wherein the first riser is configured to nest within the second riser.

11. The brushing system of claim 10, wherein the charging base further comprises:
a base protrusion extending vertically upwards from the first riser, the base protrusion having a slanted tip and containing the second charging coil therein.

12. The brushing system of claim 11, wherein the powered toothbrush further comprises:
a recess defined in a bottom end of the powered toothbrush, the recess being configured to accept the protrusion of the charging cup, the base protrusion, and the second charging coil inserted therein.

13. A method of charging a powered toothbrush comprising:
inserting a universal serial bus (USB) header on a bottom end of a charging base into a universal serial bus (USB) receptacle on a top end of a charger that is plugged into a wall outlet;
directing an electrical current from the wall outlet through the charger and into the charging base via the USB receptacle and the USB header;
converting the electrical current into electromagnetic energy via a first charging coil provided in the charging base;
directing the electromagnetic energy from the first charging coil to a second charging coil provided within a powered toothbrush;
converting the electromagnetic energy back into an electrical current;
delivering the electrical current to a rechargeable battery provided within the powered toothbrush; and
recharging the rechargeable battery.

14. The method of claim 13, further comprising:
inserting the first charging coil into an opening defined in the second charging coil prior to directing the electromagnetic energy from the first charging coil to the second charging coil.

15. The method of claim 13, further comprising:
connecting a top end of the charging base to a bottom end of a charging cup prior to inserting the first charging coil into the opening in the second charging coil such that the first charging coil extends into an interior of a projection provided in the bottom end of the charging cup and thereby into the opening in the second charging coil.

16. The method of claim 13, further comprising:
delivering the electrical current to the rechargeable battery in the powered toothbrush until the rechargeable battery reaches a maximum capacity; and
terminating the delivery of electrical current to the rechargeable battery once the maximum capacity is reached.

17. The method of claim 13, further comprising:
delivering the electrical current to the rechargeable battery in the powered toothbrush until the rechargeable battery reaches a maximum capacity; and
reducing the amount of electrical current being delivered to the rechargeable battery to maintain the rechargeable battery at its maximum capacity.

18. The method of claim 13, further comprising:
delivering the electrical current to the rechargeable battery in the powered toothbrush until the rechargeable battery reaches a maximum capacity;
terminating the delivery of electrical current to the rechargeable battery until the rechargeable battery depletes below a preset level; and
resuming delivery of the electrical current to the rechargeable battery to restore the rechargeable battery to its maximum capacity.

19. The method of claim 13, further comprising:
directing the electrical current through a printed circuit board (PCB) within the charging base before converting the current into the electromagnetic energy.

20. The method of claim 19, further comprising:
orienting the PCB within the charging base to be above and orthogonal to the plane of one or more prongs on the charger.
